(19) United States
(12) Patent Application Publication
(10) Pub. No.: US 2002/0049976 A1
(43) Pub. Date: Apr. 25, 2002

(54) Receiver of data coming from many programs and method of receiving one of many programs

(76) Inventor: Philippe Gentric, Issy Les Moulineaux (FR)

Correspondence Address: Corporate Patent Counsel, U.S. Philips Corporation, 580 White Plains Road, Tarrytown, NY, 10591, US

(21) Appl. No.: 09/963,630

(22) Filed: Sep. 26, 2001

(30) Foreign Application Priority Data
Sep. 29, 2000 (FR) 0012457

(51) Int. Cl. G06F 3/00; H04N 5/445; G06F 13/00

(52) U.S. Cl. 725/61; 725/46; 725/47

(57) ABSTRACT

This data receiver (1) is intended to receive many digital programs coming from the Internet, for example. This receiver comprises a plurality of program receiving devices (40, 41, 42, 43, 44, . . . ) for receiving programs according to a pre-established criterion. A remote control box (32) displays a part of the programs. A shift of this list clears and loads one of the receiving devices on the basis of another program.

The invention relates to a receiver of data coming from many programs.

The invention also relates to a method of receiving one of many programs.

The invention finds interesting applications when notably the programs are television programs and/or radio programs supplied by means of the Internet or a network of this type.

From patent document PCT WO 99/40506 is known a method of navigating among these many programs. However, this method gives no solution whatever for managing the reception of a large number of programs, which necessitates a rather complex reception process.

The invention proposes a receiver of the type mentioned in the opening paragraph which solves the problem of the reception of the programs, which reception necessitates complex receiving functions while a certain navigation comfort of the many programs is offered.

Such a receiver is characterized in that it furthermore comprises a plurality of other program receiving devices for receiving programs according to a pre-established criterion.

These and other aspects of the invention are apparent from and will be elucidated, by way of non-limitative example, with reference to the embodiment(s) described hereinafter.

In the drawings:

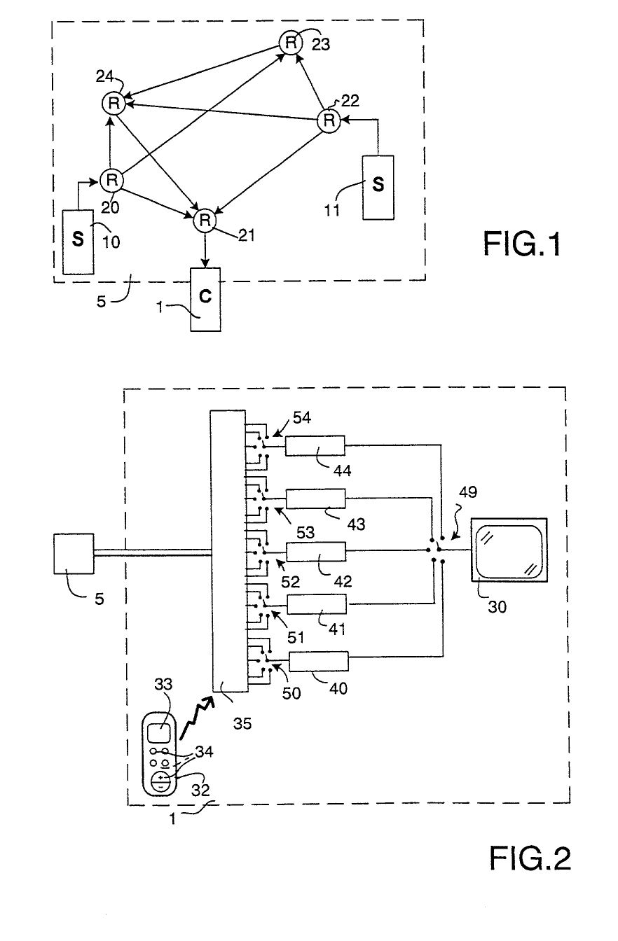

FIG. 1 shows a transmission system in which the invention is implemented,

FIG. 2 shows a receiver in accordance with the invention,

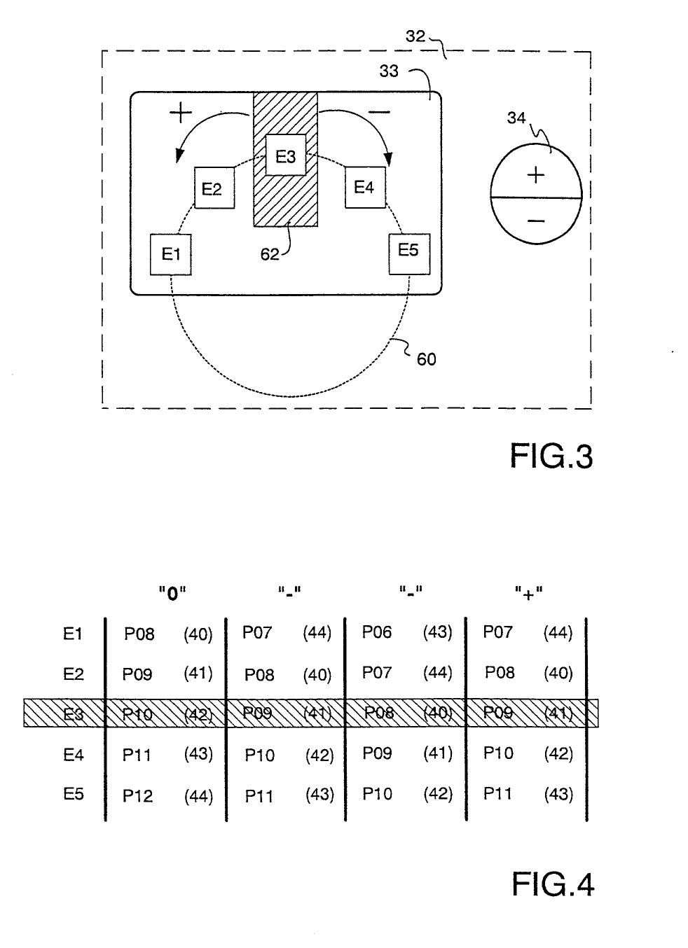

FIG. 3 shows a first arrangement of the program references and

FIG. 4 shows a second arrangement of the program references.

In FIG. 1 is shown a receiver 1 in accordance with the invention, connected to the Internet 5. This network comprises multi-media data servers, two of which are represented in FIG. 1. They are the servers referred to as 10 and 11. The receiver 1 and the servers 10 and 11 are interconnected via nodes 20 to 24.

For reproducing these data, which appear in digital form, various operations are carried out which require processing time. This time becomes unbearable for a user who often changes programs.

For example, if one looks at the case where the data are television broadcasts transmitted by means of the MPEG-4 standard, one is already subjected to the delay of the random-access points (RAP) which appear in the stream of transmitted data. These points correspond to reference images and, it is on the basis of these points that various updates are made to establish the continuity of the image sequences. These points occur in time periods whose order of magnitude is several seconds. This calls forth the drawback that when one changes programs, one has to wait at least for these several seconds, which is highly annoying to the user.

The receivers use the pipeline technique to carry out their processing. This requires that various signal frames are received before the user sees the program.

The buffer memories, which are used for these processings, further delay the appearance of these programs.

Still more serious is the delay owing to the program distribution via a network of the Internet type: the user is to make his request; a path is created among the various nodes for each data packet transmitted by the servers; the result is fluctuations of which the receiver is to get rid of by adding a delay that cancels these fluctuations.

The receiver 5 diagrammatically shown in FIG. 2 permits to largely solve the feeling of delay when programs are changed. This receiver comprises a reproduction element 30 which incorporates a display screen and other multi-media devices, notably sound. It also comprises an indication element formed here by a remote control box 32 which has a screen 33 and a keypad 34, which keypad permits to change the program for the reproduction element 30. This keypad 34 notably comprises “+” and “−” keys to be able to change the number of programs continuously. An interface circuit 35 ensures the link to the Internet 5.

In accordance with the invention, this receiver comprises a plurality of receiving devices 40, 41, 42, 43 and 44, operating in parallel. The reproduction element is connected to the output of one of these receiving devices. This is shown by a switch 49. All these devices can receive all the programs of the Internet; this is shown by the switches 50 to 54 connected to the inputs of the devices 40 to 44, respectively.

FIG. 3 shows how the titles of the programs, or their references, are positioned on the screen 33 of the remote control box 32. Preferably, the references of the programs are brought to the positions E1 to E5, of which the numbers correspond to the numbers of the respective receiving devices. These positions lie along a circle 60 of which only an arc is visible on screen 33. When the “+” and “−” keys of the keyboard 34 are touched, one has the impression that the references of the programs to be reproduced are rotated. These references are defined according to a certain criterion, for example, all the programs coming from certain sites. A central area 62, represented in hatched form, determines the selected program. In some way a carrousel has been formed. FIG. 4 shows how the references of programs of a list of a hundred programs or more are displayed and what the receiving devices are which are involved when the “+” and “−” keys are pressed.

In this figure, various columns are shown, column “0” representing the initial state under consideration of the remote control. At positions E1 to E5 the references P08 to P12 of programs are displayed respectively. These programs are processed by the receiving devices 40 to 44, respectively. The references of these devices are put in brackets in this figure. When the “−” key is pressed a first time, the reference of program P9 is found at position E3. The program P12 is no longer visible and the receiving device 44, which has been assigned thereto is rendered available, so that, once the “−” key is pressed the first time, the device is prepared to process the data of the program referenced P07. When this “−” key is pressed a second time, there is thus another rotation of the references of the displayed programs; this time it is the program whose reference is P08 that is selected, whereas the receiving device 43 is made free to process the program whose reference is P06. If the “+” key is pressed, it is the same case as when the “−” key is pressed for the first time.

Thus the displayed list of the programs evolves as a function of the choice of the user.

Thus one realizes that the user is to press a key at least two times to select a program that has not yet been processed by one of the receiving devices. While supposing that the user watches the program several times with each press of a key, these times may be sufficient to establish the reproduction of the new program that comes back to the carrousel.

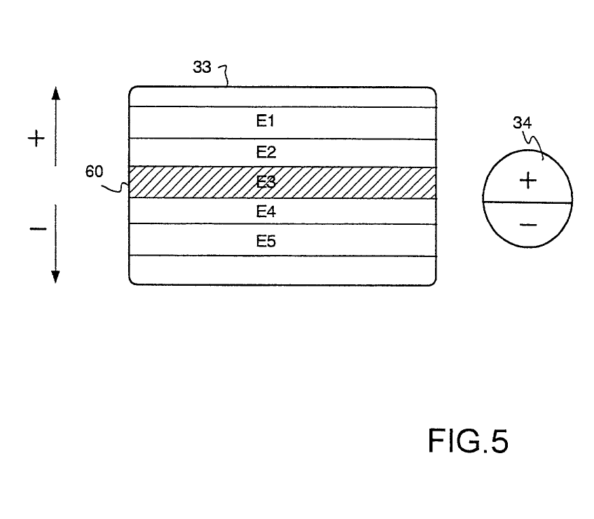

With the layout as a carrousel, which is thought to be agreeable, one may prefer a scroll layout as represented in FIG. 5. The various positions E1 to E5 are placed on different lines of the screen 33. By playing with the “+” and “−” keys the references of the programs are displaced vertically. The central hatched line represents the selected program.

It is also possible to vary the hatched selection area, but when the area reaches the stop, the user has no longer information about the programs situated beyond the stop.

Thus the programs are accessible in a sequential manner to clear and load one of the receiving devices.

The programs processed by the various receiving devices can correspond to the user's favorite programs; this may form another criterion.

1. A receiver of data coming from many programs, the receiver comprising a first program receiving device, characterized in that the receiver moreover comprises a plurality of other program receiving devices for receiving programs according to a pre-established criterion.

2. A receiver as claimed in claim 1, characterized in that it comprises a program indication element which shows a list of the programs that correspond to said pre-established criterion.

3. A receiver as claimed in claim 1 or 2, characterized in that the pre-established criterion corresponds to a certain number of programs higher than the number of receiving devices and in that the receiver comprises a program indication element which shows the list of a part of the programs evolving as a function of the user's choice.

4. A receiver as claimed in one of the claims 1 to 3, characterized in that the access of the programs takes place in a sequential manner by clearing and loading one of the receiving devices.

5. A receiver as claimed in one of the claims 1 to 4, characterized in that the programs come from the Internet.

6. A method of receiving data coming from many programs used in a receiver as claimed in one of the claims 1 to 4, characterized in that it comprises the following steps:
making up a list of programs that may be received,
simultaneously receiving a plurality of programs of said list,
selecting one of the programs from said plurality.

7. A method as claimed in claim 6, characterized in that a change of said plurality clears at least one reception to receive another program of said list.
